(19) United States
(12) Patent Application Publication
(10) Pub. No.: US 2013/0185166 A1
(43) Pub. Date: Jul. 18, 2013

(54) CARDHOLDER MOBILE DEVICE POSITIONING SYSTEM AND METHOD

(71) Applicant: Colin Larkin, Co. Dublin (IE)

(72) Inventor: Colin Larkin, Co. Dublin (IE)

(73) Assignee: MOQOM LIMITED, Co.Dublin (IE)

(21) Appl. No.: 13/811,554

(22) PCT Filed: Jul. 19, 2011
(86) PCT No.: PCT/EP2011/062327

§ 371 Date: Apr. 4, 2013

(30) Foreign Application Priority Data
Jul. 20, 2010 (IE) S2010/0453

(51) Int. Cl. G06Q 20/32

(52) U.S. Cl. CPC G06Q 20/3224
USPC 705/21

(57) ABSTRACT

A method and system processes location data associated with a transaction in an electronic transaction processing system. The system comprises at least one point of sale terminal, such as a merchant terminal or ATM terminal, and at least one cardholder mobile terminal, each terminal being connected to a network and associated with a same electronic transaction. Data representative of the geographical location of the at least one point of sale terminal and data representative of the geographical location of the at least one cardholder mobile terminal is also obtained. The respective positional data of the terminals is compared, and an alert message is communicated over the network if the comparison indicates that the terminals are not located within a predetermined proximity to one another. The transaction can be authorised or rejected based on the position of the cardholder at the time to the transaction.

### FIELD OF INVENTION

The invention relates to a system and method for preventing fraud in electronic transaction processing systems. In particular, the invention relates to a system and method for preventing fraud in electronic card payment processing systems.

### BACKGROUND

The fraudulent use of payment cards, including both debit and credit cards, is an ever increasing problem for financial institutions. The introduction of card chip and associated personal identification number (PIN) technology has aimed at resolving the problem, and card fraud in certain transaction contexts has declines, however at the expense of increased fraud with electronic transaction not involving PIN.

Examples of various types of card fraud are summarised hereafter.

Card-Not Present (CNP)

Card-not present (CNP) refers to Internet, phone and mail order fraud. This type of fraud occurs when card details are stolen to pay for services and goods over the phone, the Internet or by mail order. The main problem for countering this type of fraud is that the cardholder is not present during the transaction and usually does not know about the fraudulent use until well after the transaction has been processed.

Counterfeit Fraud

Counterfeit fraud refers to situations wherein criminals copy magnetic stripe details of a payment card and create one or more clones from the copied data. Such counterfeit cards are generally used overseas, in locations wherein chip and PIN technology has yet to be introduced.

Lost and Stolen Card Fraud

Lost and stolen card fraud refers to fraud using cards that have been reported lost or stolen by the cardholder. Most lost and stolen card fraud takes place in shops that are yet to introduce chip and PIN equipment. The fraudulent user does not require a PIN to use the card, and can therefore use it before the cardholder has reported the card lost or stolen. Prior art solutions trying to counteract this type of fraud analyse cardholder accounts for unusual spending patterns in near real-time, and lost and stolen card fraud has reduced in recent years, however still unsatisfactorily.

Mail Non-Receipt Fraud

Mail non-receipt fraud refers to fraudulent use of payment cards that have been stolen in transit, between the time card companies issue and mail them and the time at which the intended recipient cardholders should receive them. This type of fraud occurs most in apartment buildings or when cardholders fail to redirect their mail after a house move. This type of fraud has also declined in recent years, as fewer cards are issued for longer periods of authorised use, and because the existing cardholder PIN is often maintained, such a new PIN is not sent out.

Card ID Theft

Card ID theft refers to situations wherein criminals use fraudulently obtained cards or card details, along with stolen personal information, to open or take over a card account in someone else's name. There are two main types:

Application fraud refers to criminals using stolen or fake documents to open an account under another name or alias. Criminals may illegally obtain documents such as genuine utility bills and financial institution statements and/or may use counterfeited documents, to accrue personal information and falsify account application details.

Account take-over refers to criminals taking over another person's account, first by gathering information about the intended victim, then contacting their financial institution or credit card issuer whilst masquerading as the genuine cardholder. The criminal can then transfer funds out of the account or can change the address on the account and ask for new or replacement cards to be sent to the changed address.

ATM Fraud

ATM Fraud is carried out by criminals who copy the magnetic stripe and record the PIN of cards when cardholders use Automatic Teller Machines. There are three main types:

Shoulder surfing refers to situations wherein a criminal looks over a cardholder shoulder to observe and obtain their PIN, then later steals the card using a distraction technique.

Card-tapping refers to situations wherein a criminal inserts a device into the ATM card slot, which retains the card. The criminal usually tricks the cardholder into inputting their PIN again and, when the cardholder leaves, the criminal uses the card so stolen with the obtained PIN to withdraw currency.

Skimming refers to situations wherein a criminal attaches a skimming device to the ATM for recording the electronic details from the magnetic stripe of genuine cards as they are inserted into the ATM. A miniature camera is hidden overlooking the PIN pad to capture the PIN being entered. Criminals then use the obtained data to produce fake magnetic stripes and use genuine PIN's to withdraw money from overseas ATMs.

Further to the success of chip and PIN technology in Cardholder—present transactions, criminals are increasingly targeting transactions for which this technology is not, or not yet used. Such transactions are essentially Card-Not-Present transactions such as Internet transactions and overseas transactions in countries where this technology has yet to be implemented.

Another problem faced by financial institutions is maintaining the correct and latest contact information for cardholders they are financially responsible for. Cardholders often update or change mobile phone numbers and fail to inform the financial institutions about any changes.

It is therefore an object of the invention to provide a fraud prevention system and method to overcome at least some of the problems mentioned above.

### SUMMARY

According to a first aspect of the present invention, there is provided a method of processing location data associated with a transaction in an electronic payment system comprising at least one point of sale terminal and at least one cardholder mobile terminal, each terminal being connected to a network, the method comprising the steps of obtaining data representative of the geographical location of the at least one point of sale terminal; obtaining data representative of the geographical location of the at least one cardholder mobile terminal; comparing the respective positional data of the at least one point of sale terminal and of the at least one cardholder mobile terminal; and communicating an alert message over the network if the comparison indicates that the at least one point of sale terminal and the at least one cardholder mobile terminal are not located within a predetermined proximity to one another.

The method preferably comprises the further steps of associating a network address of the at least one cardholder mobile terminal with a unique identifier representative of a respective financial account or payment card; and associating the associated network address and unique identifier with a financial institution host terminal.

The step of associating a network address of the at least one cardholder mobile terminal with a unique identifier representative of a respective financial account or payment card preferably comprises the further step of verifying the network address of the at least one cardholder mobile terminal.

In one embodiment the at least one point of sale terminal is a bank ATM terminal.

In one embodiment the alert message comprises one or more of an SMS message, MMS message, voice message (for example an automated voice message, or e-mail message.

The step of verifying preferably comprises the further step of communicating the network address from the at least one cardholder mobile terminal to the financial institution host terminal.

The step of verifying may comprise the further step of determining whether the network address is valid or invalid. Alternatively, or additionally, the step of verifying may comprise the further step of determining whether the at least one cardholder mobile terminal is active or inactive.

The alert message is preferably communicated to the financial institution host terminal associated with the at least one cardholder mobile terminal.

The predetermined proximity is preferably a geographical area selected from the group comprising administratively—defined areas, network—defined areas, areas determined by the at least one cardholder mobile terminal, or any combination thereof.

The step of obtaining data representative of the geographical location of the at least one cardholder mobile terminal may comprise the further step of sending a Mobile Application Part (MAP) message over the network. Preferably, the step of sending a MAP message comprises the further step of sending a MAP Send Routing Information (SRI) or Send Routing Information Short Message query. It will be appreciated that Mobile Application Part specifications were originally defined by the GSM Association, but are now controlled by ETSI/3GPP. MAP is defined by two different standards, depending upon the mobile network type: MAP for GSM (prior to Release 4) is specified by 3GPP TS 09.02MAP for UMTS (“3G”) and GSM (Release 99 and later) is specified by 3GPP TS 29.002.

Alternatively, the at least one cardholder mobile terminal comprises global positioning means, whereby the step of obtaining data representative of the geographical location of the at least one cardholder mobile terminal may comprise the further step of obtaining global positioning coordinates from the at least one cardholder mobile terminal.

The method preferably comprises the further step of authenticating the transaction if the comparison indicates that the at least one point of sale terminal and the at least one cardholder mobile terminal are located within the predetermined proximity to one another.

The steps of obtaining data respectively representative of the geographical location of the at least one point of sale terminal and of the at least one cardholder mobile terminal, comparing the respective positional data and communicating an alert message over the network are preferably performed by a host terminal connected to the network. The steps of associating and of verifying may also be performed by the host terminal connected to the network.

According to another aspect of the present invention, there is a provided an electronic transaction system comprising at least one point of sale terminal and at least one cardholder mobile terminal, the system comprising means for obtaining data representative of the geographical location of the at least one point of sale terminal, means for obtaining data representative of the geographical location of the at least one cardholder mobile terminal, means for comparing the respective positional data of the at least one point of sale terminal and of the at least one cardholder mobile terminal, and means for communicating an alert message over the network if the comparison indicates that the at least one point of sale terminal and the at least one cardholder mobile terminal are not located within a predetermined proximity to one another.

The system preferably further comprises means for associating a network address of the at least one cardholder mobile terminal with a unique identifier representative of a respective financial account or payment card, and means for associating the associated network address and unique identifier with a financial institution host terminal.

The means for associating a network address of the at least one cardholder mobile terminal with a unique identifier representative of a respective financial account or payment card preferably further comprises means for verifying the network address of the at least one cardholder mobile terminal.

The verifying means preferably further comprises means for communicating the network address from the at least one cardholder mobile terminal to the financial institution host terminal.

The verifying means may further comprise means for determining whether the network address is valid or invalid. Alternatively, or additionally, the verifying means may further comprise means for determining whether the at least one cardholder mobile terminal is active or inactive.

The means for communicating an alert message is preferably adapted to communicate the alert message to the financial institution host terminal associated with the at least one cardholder mobile terminal.

The predetermined proximity is preferably a geographical area selected from the group comprising administratively—defined areas, network—defined areas, areas determined by the at least one cardholder mobile terminal, or any combination thereof. For example the geographic area can be defined in terms of a radius from a geographical point, a number of blocks from the current location, street, city, county, country etc.

The means for obtaining data representative of the geographical location of the at least one cardholder mobile terminal may be adapted to communicate a Mobile Application Part (MAP) message over the network. Preferably, the obtaining means is further adapted to communicate a MAP Send Routing Information (SRI) or Send Routing Information Short Message query.

Alternatively, the means for obtaining data representative of the geographical location of the at least one cardholder mobile terminal is a global positioning means of the at least one cardholder mobile terminal.

The system preferably further comprises means for authenticating the transaction if the comparison indicates that the at least one point of sale terminal and the at least one cardholder mobile terminal are located within the predetermined proximity to one another.

The means for obtaining data respectively representative of the geographical location of the at least one point of sale terminal and of the at least one cardholder mobile terminal, the means for comparing the respective positional data and the means for communicating an alert message over the network are preferably embodied in a host terminal connected to the network. The associating means and the means for verifying may also be embodied in the host terminal connected to the network.

According to a further aspect of the present invention, there is a provided a set of instructions recorded on a data carrying medium which, when processed by a data processing terminal connected to a network, configures the terminal to perform the steps of obtaining data representative of the geographical location of at least one point of sale terminal connected to the network or another network and associated with an electronic transaction, obtaining data representative of the geographical location of at least one cardholder mobile terminal connected to the network or another network and associated with the electronic transaction, comparing the respective positional data of the at least one point of sale terminal and the at least one cardholder mobile terminal, and communicating an alert message over the network if the comparison indicates that the at least one point of sale terminal and the at least one cardholder mobile terminal are not located within a predetermined proximity to one another.

Other aspects of the present invention are as described and claimed herein.

### BRIEF DESCRIPTION OF THE DRAWINGS

The invention will be more clearly understood from the following description of an embodiment thereof, given by way of example only, with reference to the accompanying drawings, in which:

FIG. 1 shows a networked environment in which an embodiment of the invention is implemented, including a plurality of terminals.

FIG. 2 shows a hardware structure of a cardholder mobile terminal shown in FIG. 1.

FIG. 3 is an overview of a Mobile Phone Number Validation system according to an embodiment of the present invention in the environment of FIG. 1;

FIG. 4 details the processing steps according to which the system of FIG. 3 validates a network address, for instance a mobile terminal number.

FIG. 5 is an overview of a Short Message Service Mobile Phone Number Registration system according to an embodiment of the present invention in the environment of FIG. 1;

FIG. 6 details the processing steps according to which the system of FIG. 5 registers a network address, for instance a mobile terminal number.

FIG. 7 is an overview of a Cardholder Mobile Location system according to an embodiment of the present invention in the environment of FIG. 1;

FIG. 8 details the processing steps according to which the system of FIG. 7 locates a cardholder mobile terminal.

FIG. 9 is an overview of a Cardholder Mobile Location system according to another embodiment of the present invention in the environment of FIG. 1, in which the cardholder location is retrieved with a network location request; and

FIG. 10 is an overview of a Cardholder Mobile Location system according to yet another embodiment of the present invention in the environment of FIG. 1, in which the cardholder location is retrieved with a global positioning feature of the cardholder mobile terminal.

### DETAILED DESCRIPTION OF THE PREFERRED EMBODIMENTS

The words “comprises/comprising” and the words “having/including” when used herein with reference to the present invention are used to specify the presence of stated features, integers, steps or components but does not preclude the presence or addition of one or more other features, integers, steps, components or groups thereof.

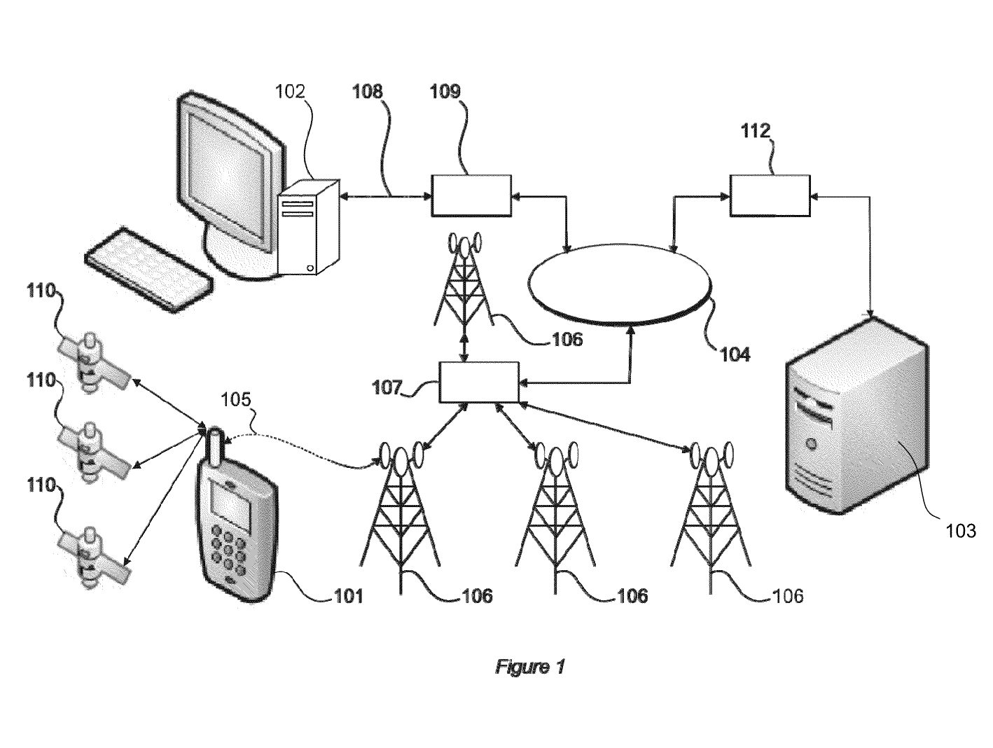

FIG. 1 shows a networked environment in which an embodiment of the invention is implemented, including a plurality of terminals. The electronic transaction processing system comprises at least one cardholder mobile terminal 101, at least one point of sale terminal 102 and at least one host terminal 103, each terminal being connected to a communication network 104.

In the example, the cardholder mobile terminal 101 is a mobile telephone handset having wireless telecommunication emitting and receiving functionality over a cellular telephone network configured according to the Global System for Mobile Communication (‘GSM’), General Packet Radio Service (‘GPRS’), International Mobile Telecommunications-2000 (IMT-2000, ‘3G’) network industry standards, and wherein telecommunication is performed as voice, alphanumeric or audio-video data using the Short Message Service (‘SMS’) protocol, the Wireless Application protocol (‘WAP’) the Hypertext Transfer Protocol (‘HTTP’) or the Secure Hypertext Transfer Protocol (‘HTTPS’).

The cardholder handset 101 receives or emits any type of data, for example voice, text, audio and/or image data, encoded as a digital signal over a wireless data transmission 105, wherein the signal is relayed respectively to or from the handset by the geographically-closest communication link relay 106 of a plurality thereof. The plurality of communication link relays 106 allows digital signals to be routed between the handset 101 and their destination by means of a remote gateway 107. Gateway 107 is for instance a communication network switch, which couples digital signal traffic between wireless telecommunication networks, such as the network within which wireless data transmissions 105 take place, and the communication network 104, which can be a Wide Area Network (‘WAN’) 104, an example of which being the Internet, or Local Area Network (LAN). The gateway 107 further provides protocol conversion if required, for instance whether the handset 101 uses a WAP or HTTPS protocol, or other suitable protocol, to communicate data.

Alternatively, or in addition, the cardholder mobile terminal 101 may have wireless telecommunication emitting and receiving functionality over a wireless local area network (‘WLAN’) conforming to the IEEE 802.11 standard (‘Wi-Fi’) and wherein telecommunication is likewise performed as voice, alphanumeric or audio-video data using the Voice data over IP (‘VoIP’) protocol, the Hypertext Transfer Protocol (‘HTTP’) or the Secure Hypertext Transfer Protocol (‘HTTPS’), the signal being relayed respectively to or from the cardholder mobile terminal 101 by a wireless router 109 interfacing the mobile telephone handset 101 to the WAN communication network 104.

The cardholder mobile terminal 101 preferably has wireless global positioning means, for instance a Global Positioning System (GPS). GPS uses 24 global satellites that orbit the Earth to send signals to a GPS-enabled receiver such as the cardholder mobile terminal 101 of the example. The handset 101 communicates with three or four satellites 110 at any single point in time and, as the handset 101 obtains the positioning measurements, it can either calculate the location coordinates locally, or send the measurements to a remote host terminal, for instance the at least one host terminal 103, to offload local processing requirements.

The cardholder mobile terminal 101 may for instance be, but not limited to, an iPhone™ handset manufactured by the Apple Corporation or a Nexus One™ handset manufactured for Google, Inc. by the HTC Corporation. Generally, the cardholder mobile terminal 101 may be any portable data processing device having at least wireless communication means.

In the example, the point of sale terminal 102 is a data processing device which emits and receives data encoded as a digital signal over a wireless data transmission 108 conforming to the IEEE 802.11 (‘Wi-Fi’) standard, wherein the signal is relayed respectively to or from the computing device by the wireless router 109 interfacing the computing device 102 to the WAN communication network 104. In other examples the point of sale terminal 102 can be connected via phone line or an internet connection.

The computing device may alternatively emit and receive data encoded as a digital signal over a wired data transmission conforming to the IEEE 802.3 (‘Gigabit Ethernet’) standard, wherein the signal is relayed respectively to or from the computing device by a wired router interfacing the computing device to the WAN communication network 104.

Generally, the point of sale terminal 102 may be any portable or desktop data processing device computing having at least networking means apt to establish a bilateral data communication with the host terminal 103.

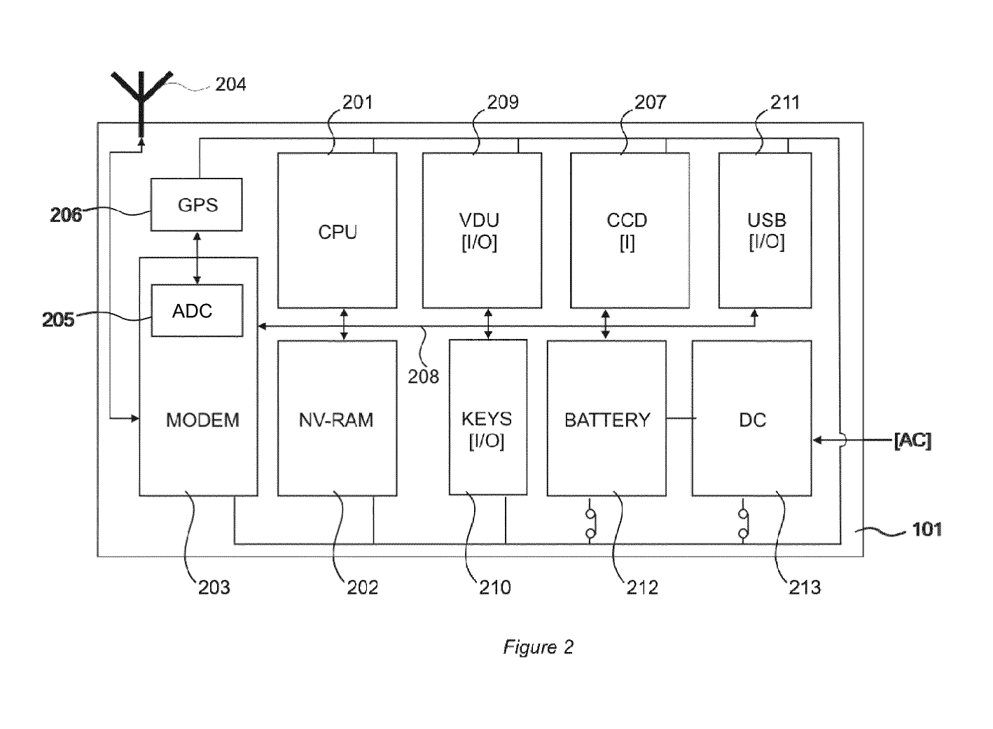

A typical hardware architecture of the cardholder mobile terminal 101 is shown in FIG. 2 in further detail, by way of non-limitative example. The handset 101 firstly includes a data processing unit 201, for instance a general-purpose microprocessor (‘CPU’), acting as the main controller of the handset 101 and which is coupled with memory means 202, comprising non-volatile random-access memory (‘NVRAM’).

The cardholder mobile terminal 101 further includes a modem 203 to implement the wireless communication functionality, as the modem provides the hardware interface to external communication systems, such as the GSM or GPRS cellular telephone network 106, 107, shown in FIG. 1. An aerial 204 coupled with the modem 203 facilitates the reception of wireless signals from nearby communication link relays 106. The modem 203 includes an analogue-to-digital converter 205 (‘ADC’) for demodulating wavelength wireless signals received via the antenna 204 into digital data, and reciprocally for outgoing data.

The handset 101 further includes self-locating means in the form of a GPS receiver 206, wherein the ADC 205 receives analogue positional and time data from orbiting satellites 110, which the data processing unit 201 or a dedicated data processing unit processes into digital positional and time data.

The handset 101 may optionally further include imaging means 207 in the form of an electronic image sensor, for capturing image data which the data processing unit 201 or a dedicated data processing unit processes into digital image data.

The CPU 201, NVRAM 202, modem 203, GPS receiver 206 and optional digital camera 207 are connected by a data input/output bus 208, over which they communicate and to which further components of the handset 101 are similarly connected, in order to provide wireless communication functionality and receive user interrupts, inputs and configuration data. Alphanumerical and/or image data processed by CPU 201 is output to a video display unit 209 (‘VDU’), from which user interrupts may also be received if it is a touch screen display. Further user interrupts may also be received from a keypad 210 of the handset, or from an external Human interface Device (‘HiD’) connected to the handset via a Universal Serial Bus (‘USB’) interface 211. The USB interface advantageously also allows the CPU 201 to read data from and/or write data to an external or removable storage device. Power is provided to the handset 101 by an internal module battery 212, which an electrical converter 213 charges from a mains power supply as and when required.

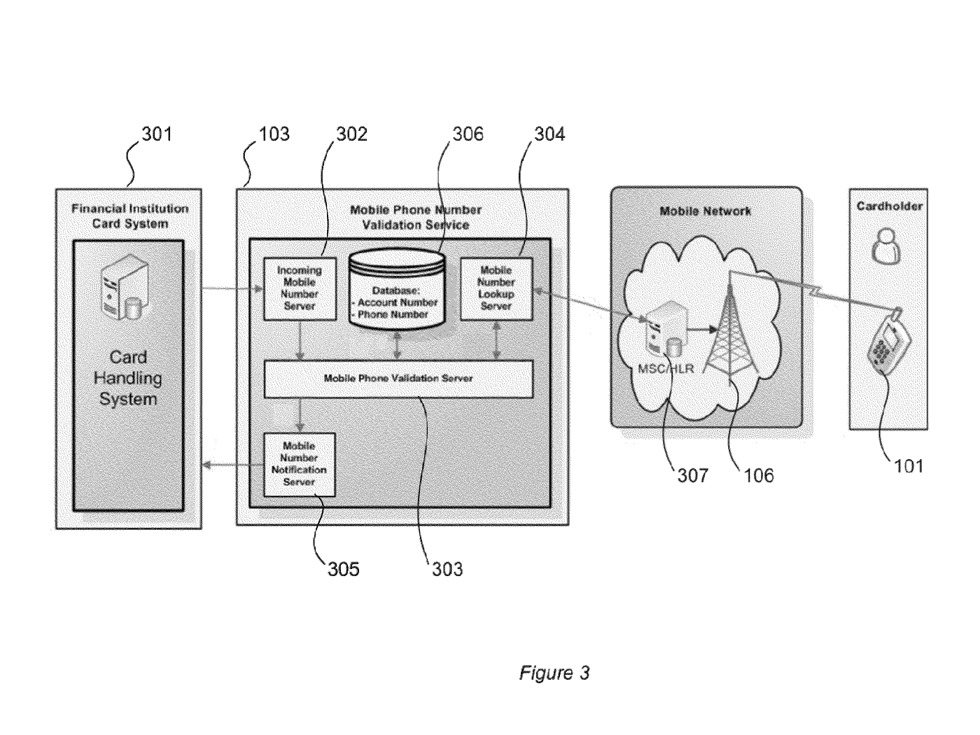

FIG. 3 shows a cardholder mobile phone network address validation system embodied in the environment of FIG. 1 according to the present invention. The system includes the terminal 103 configured as a plurality of function—specific servers 302, 303, 304, 305 and storing a database 306. The function—specific servers are adapted to obtain one or more account numbers of each cardholder and the respective network address of the mobile terminal of each cardholder from a financial institution terminal 301, and to process each network address to check whether the obtained network address is valid or not.

In a preferred embodiment, the network address is the phone number assigned to the terminal 101 by the wireless communication service provider, and the system provides a MAP SEND_ROUTING_INFORMATION Request to a Home Location Register (HLR) 307 for each number to check if the number is still valid or not.

The system thereafter communicates the outcome of the checking operation to the financial institution terminal 301, indicating whether the number for each cardholder is valid or not. The financial institution terminal 301 is configured to identify cardholders who have provided an incorrect number.

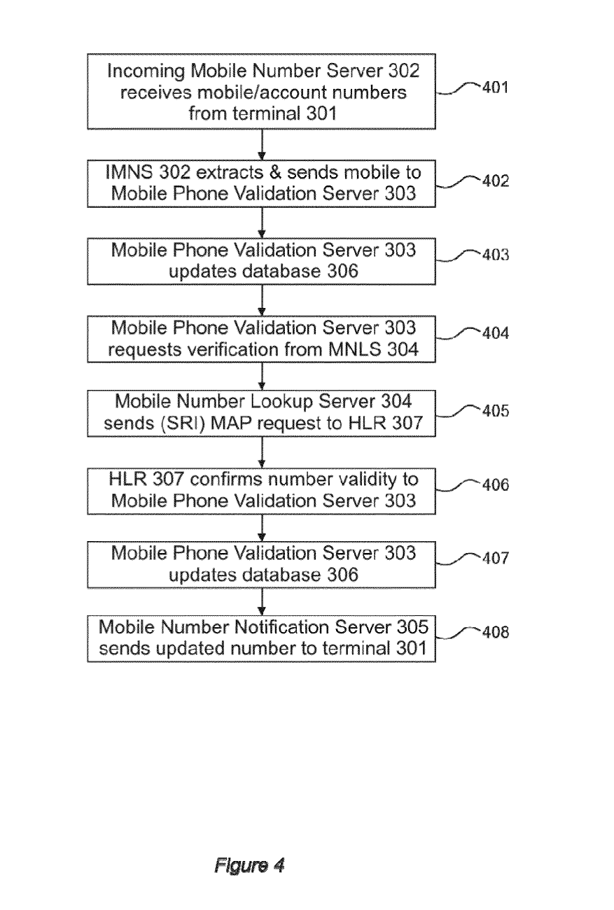

Steps according to which the system validates a network address, for instance the phone number, are detailed in FIG. 4.

At step 401, both the phone number of the cardholder mobile terminal currently stored at the financial institution terminal 301 (shown in FIG. 3) in respect of the cardholder's account number and the cardholder's account number (real or aliased for security purposes) are sent to an Incoming Mobile Number Server 302, in the example the host terminal 103 suitably configured. The information can be received over any available interface, such as HTTP, HTTPS, CORBA, XML, FTP, SFTP and the like.

At step 402, the Incoming Mobile Number Server 302 processes the incoming account number and phone number data received from the financial institution terminal 301 to extract the information and communicates it to a Mobile Phone Validation Server 303.

At step 403, the Mobile Phone Validation Server 303 updates the database 306 stored at host terminal 103 with the extracted account number and mobile number for the cardholder.

At step 404, the Mobile Phone Validation Server 303 then requests a Mobile Number Lookup Server 304 to verify the cardholder's mobile number. At step 405, the Mobile Number Lookup Server 304 performs a Send_Routing_Information (SRI) MAP request for the extracted mobile number to the HLR 307, which contains the address of the Mobile Switching Centre (MSC). At step 406, the MSC/HLR communicates a response to the Send_Routing_Information (SRI) request to the Mobile Phone Validation Server 303 as to whether the mobile phone number is a valid number or not, and optionally whether it is in use or not.

At step 407, the Mobile Phone Validation Server 303 update the internal database 306 for the cardholder to indicate whether or not the mobile number received from the financial institution terminal 104 is valid or not, based on the response of step 406.

At step 408, a Mobile Number Notification Server 305 communicates the updated number data to the financial institution terminal 301 representative of the status of the cardholder's mobile number. The information can be communicated to the financial institution terminal 301 over any available interface, such as HTTP, HTTPS, CORBA, XML, FTP, SFTP and the like.

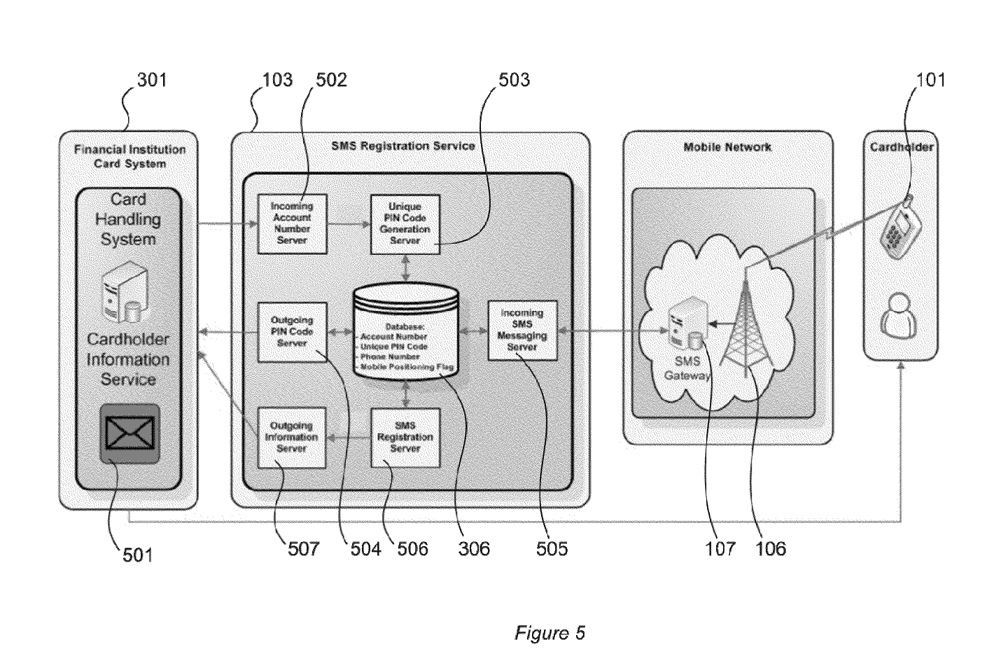

FIG. 5 shows a mobile phone network address registration system embodied in the environment of FIG. 1 according to the present invention. The system comprises the terminal 103 configured as a plurality of function—specific servers 502, 503, 504, 505, 506, 507 and storing the database 306. The function—specific servers are adapted to obtain one or more account numbers of each cardholder from a financial institution terminal 301, generate a unique PIN code for each account number as an alphanumeric number of any configurable length and communicate the generated PIN code to the financial institution terminal 301. The account numbers can be received individually or in batches from the financial institution terminal 301.

Upon receiving the generated PIN codes, the financial institution terminal 301 may process and output a respective communication 501 to each cardholder, containing a registration phone number, keyword(s), and the cardholder—respective unique generated PIN code, which the cardholder can then use to register their mobile number in the system. In the example, the cardholder registers their mobile phone number by sending a short message service (SMS) (or equivalent MMS) communication to the registration phone number using the keyword and the unique PIN Code contained in the communication 501.

When the SMS is sent from the cardholder mobile terminal 101 to the registration phone number, the SMS data content is routed to the registration system hosted by the remote terminal 103 via the SMS Gateway 107. The system receives the SMS data content, including the keyword and the unique PIN code. The unique PIN code is used to identify the correct account number in the database 306.

In an useful variation of the system, the mobile phone network address registration system may be further adapted to determine whether a cardholder wish to avail of the mobile phone network address registration and/or the cardholder mobile location Service or not in the same SMS message. The cardholder may input data representative of partially and/or entirely restricted access to their mobile terminal 101, whereby relevant flags, for instance a Mobile Positioning Flag, are set to FALSE in the database 306.

The system thereafter communicates the registered cardholder's phone number (individually or in batches) to the financial institution terminal 301, so that information systems of the financial institution may be updated with the updated cardholder information.

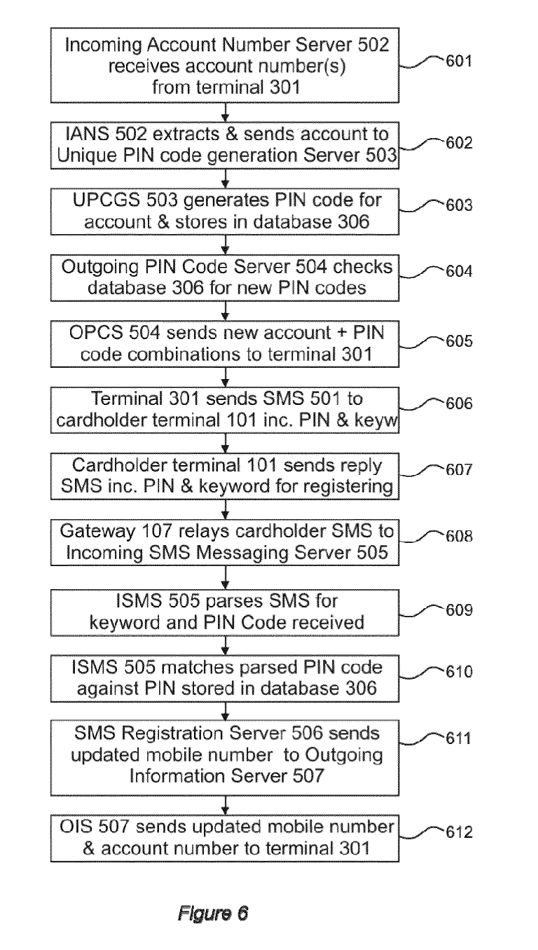

Steps according to which the system registers a network address, for instance the phone number, are detailed in FIG. 6.

At step 601, the financial institution terminal 301 communicates an individual account number or a batch of account numbers to an Incoming Account Number Server 502 of the system. The account numbers can be actual account numbers or aliased (‘dummy’) account numbers, for security purposes, for reasons of confidentiality or the like. The information can be communicated over any available interface, such as HTTP, HTTPS, CORBA, XML, FTP, SFTP and the like.

At step 602, the Incoming Account Number Server 502 processes each account number received from the financial institution terminal 301 to extract the information and communicates it to a Unique PIN Code Generation Server 503.

At step 603, the Unique PIN Code Generation Server 503 generates a unique PIN code for the extracted account number and stores it in the internal database 306 with the account number.

At step 604, an Outgoing PIN Code Server 504 checks the database, or the database engine runs a periodical query, for any new entries. The identification of one or more new entries generates a response of one or more account numbers and corresponding PIN codes, which can be communicated to the financial institution terminal 301.

At step 605, the Outgoing PIN Code Server 504 communicates the respective combinations of account numbers and PIN codes to the financial institution terminal 301. The information can be communicated over any available interface, such as HTTP, HTTPS, CORBA, XML, FTP, SFTP and the like.

At step 606, the financial institution terminal 301 processes the information received from the system at step 605 to output a respective communication 501 to each cardholder, containing a registration phone number, keyword(s), and the cardholder—respective unique generated PIN code. For instance, the financial institution terminal 301 outputs a paper or electronic mail merge and issues a corresponding letter or message 501 to each cardholder. The communication 501 to the cardholder may contain an invitation for the cardholder to avail of the mobile phone network address registration service. The communication 501 contains a phone number to which a SMS message may be sent with a keyphrase, e.g. “reg”, and the unique alphanumeric PIN code, e.g. “23ade1” generated at step 603. The communication 501 may also contain a separate keyword, e.g. “regrestrict”, which can be used by the cardholder unwilling to avail of the mobile phone network address registration service. The communication 501 may also contain yet another keyword, which can be used by the cardholder willing to avail of the mobile phone network address registration service, but unwilling to avail of the Cardholder Mobile Location Service. Data representative of whether the cardholder consents to the Cardholder Mobile Location Service is stored as a Mobile Positioning Flag for the cardholder in the database 306 question. Alternatively, the communication 501 may contain a different phone number at which to send the SMS for indicating that the cardholder wants to register their phone number, but does not want to avail of the Cardholder Mobile Location Service.

At step 607, further to receiving the communication 501 from the financial institution terminal 301, a cardholder who want to register the phone number of their mobile terminal 101 sends a SMS message, for instance with the following content: “reg 23ade1” or “regrestrict 23ade1” to the registration phone number contained in the communication 501.

At step 608, a SMS Gateway 107 routes the SMS data content of step 607 to an Incoming SMS Messaging Server 505. At step 609, the Incoming SMS Mobile Messaging Server 505 parses the information received from the SMS Gateway 107 and determines how to update the database 306 based on the keyword and PIN Code received.

At step 610, the Incoming SMS Messaging Server 505 checks the parsed PIN code against the PIN code stored in the database 306 at step 603 and, if they match, stores the sender mobile number of the incoming SMS message in the database 306 for the corresponding account number.

At step 611, a SMS Registration Server 506 forwards the updated phone numbers for the account numbers to an Outgoing Information Server 507. In a useful variation, the SMS Registration Server 506 generates a list of updated cardholder mobile numbers and corresponding account numbers at predetermined intervals, for instance daily, hourly, weekly, etc. and forwards this list to the Outgoing Information Server 507.

At step 612, the Outgoing Information Server 507 communicates the updated cardholder mobile numbers and the actual or aliased account numbers to the financial institution terminal 301, in respect of those cardholders who have registered their mobile phone numbers with the mobile phone network address registration system. The financial institution may then update their own database with the correct and latest mobile number for registered cardholders.

In a useful variation, should a customer not register with the mobile phone network address registration system after receiving the communication 501 from the financial institution terminal 301, the system is further adapted to process a script after a predetermined period, which extracts all the actual or aliased account numbers of cardholders who have not registered yet in a report. The report includes the unique PIN codes generated at step 603 and is communicated to the financial institution terminal 301, which may then communicate a reminder message 501 in due course, for instance substantially according to step 606.

The phone network address registration system of FIGS. 5 and 6 embodies a SMS registration service, which advantageously provides the host terminal 103 with valid data on the basis of which to provide a cardholder mobile positioning service, when configured as a cardholder mobile location system. However, the cardholder mobile positioning service may still be provided without the benefit of a SMS registration service, so as long as the financial institution terminal 104 itself maintains valid mobile number data for all cardholders.

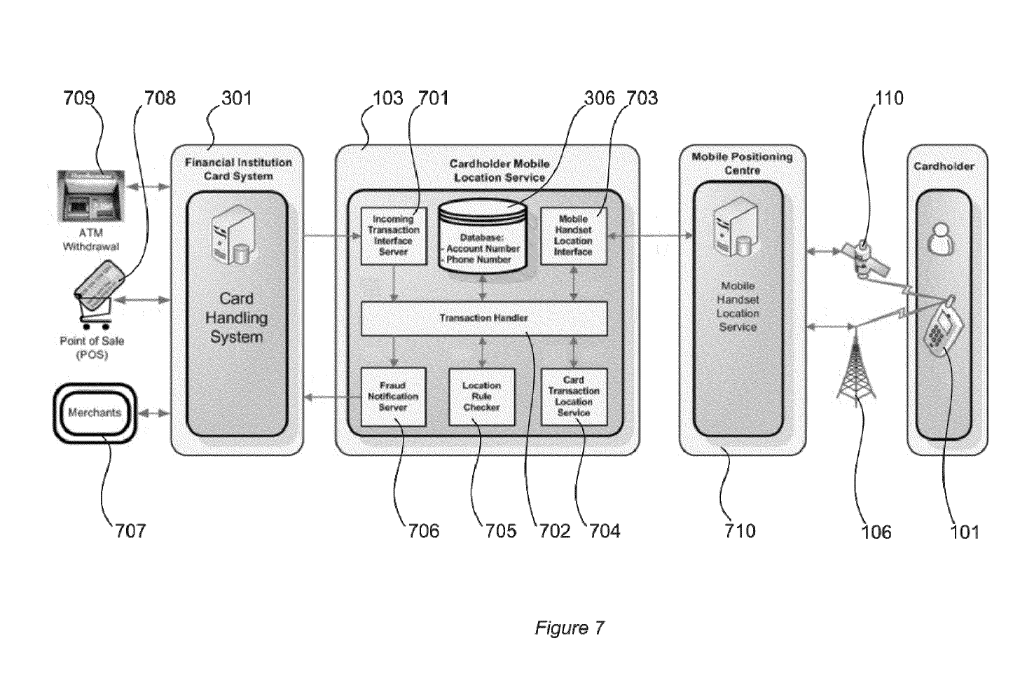

FIG. 7 shows a cardholder mobile location system embodied in the environment of FIG. 1 according to the present invention. The purpose of the cardholder mobile location system is to validate an electronic payment transaction card transaction against the location of the cardholder's mobile handset 101. The financial institution can then identify if the cardholder was in near proximity to where the card transaction occurred. The system is adapted to locate the position of the mobile terminal 101 using any amongst a plurality of mobile terminal positioning techniques.

Both mobile network—based techniques and mobile handset—based techniques can be used to determine the location of a mobile handset 101. Mobile communication services providers implement network—based technologies to provide position information for any mobile handset 101. Network—based techniques are cost—effective, but limited in accuracy. Handset—based techniques provide better accuracy, but are more expensive to implement for mobile handset producers and mobile network operators. The objective of all mobile positioning techniques is to determine the location of a mobile device 101 and process it into a meaningful X, Y coordinate.

Methods and techniques to determine the position of a mobile handset 101 include:

Cell Identity—this technique determines which cell of a wireless network the mobile handset is using, and reports its location. The base station for each cell is at a fixed location, so the cell identity can easily be translated into an approximate location of the mobile user.

Timing Advance (TA)—this technique is similar to Cell Identity, but TA can determine how far away from the base station the user is, in order to improve the accuracy of the determined location. Mobile handset location based on TA is normally acquired through a Mobile Positioning Centre (MPC). Most MPC's provide an application Programmer Interface (API) which allows the system to retrieve the cell identity data and the TA data. When the cell identity and TA techniques are combined, the combination is normally referred to as Cell Global Identity—Timing Advance (CGI—TA).

Time of Arrival (TOA)—this location technique uses GSM timing to triangulate the position of a handset 101 relative to active base stations. Accuracy is good indoors and in areas of dense base—station coverage, and TOA can be used with legacy handsets not including GPS means 206.

Angle of Arrival (AOA)—this location technique is also based on triangulation. The mobile handset position is determined by comparing the AOA of the existing reverse control channel at various cell sites.

Enhanced Observed Time Difference (E-OTD)—this technique is a variant of the mobile phone real time locating systems used in GSM phones. The basic principle of operation of the E-OTD is multilateration. E-OTD requires additional hardware to be included in the mobile terminal 101. Once the relative location is determined, it can be translated into an absolute position on the basis of the known base station coordinates.

Global Positioning System (GPS)—GPS uses 24 global satellites 110 that orbit the Earth to send signals to a GPS—enabled mobile terminal 101. The mobile terminal 101 communicates with 3 or 4 satellites at any one time, and requires a line of sight with the satellites 110. Once the mobile terminal 101 obtains the positioning data with the satellites 110, it can either calculate the location coordinates locally with a relevant application, or send the positioning data to a remote network server for processing.

A further method can be used to determine the country in which the cardholder's mobile handset is located. When a phone call is made to any given mobile phone number, the telephone switch (mobile telephone exchange) to which the initiating mobile phone is connected queries the Home Location Register (HLR) 307 in the called party's mobile network. The HLR 307 contains the address of the Mobile Switching Centre (MSC) of the called party's mobile phone. To identify the location of the mobile handset, a Mobile Application Part (MAP) Send Routing Information (SRI) Request is used to query the HLR.

The Mobile Application Part (MAP) is a Signalling System number 7 (SS7) protocol which provides an application layer for the various nodes in GSM and UMTS mobile core networks and GPRS core networks to communicate with each other, in order to provide services to mobile phone users. The MAP specifications were originally defined by the GSM Association, but are now controlled by ETSI/3GPP.

MAP is defined by two different standards, depending upon the mobile network type:

MAP for GSM (prior to Release 4) is specified by 3GPP TS 09.02.

MAP for UMTS (“3G”) and GSM (Release 99 and later) is specified by 3GPP TS 29.002.

The MAP is an application—layer protocol used to access the Home Location Register (HLR), Visitor Location Register (VLR), Mobile Switching Center (MSC), Equipment Identity Register, Authentication Centre, Short Message Service center and Serving GPRS Support Node.

The primary functions of MAP are to provide mobility services, such as location management (roaming), authentication, managing service subscription information, etc. But MAP also provides functionality for subscriber tracing and retrieving a subscriber's International Mobile Subscriber Identity (IMSI), described hereafter. A MAP service of particular relevance is the MAP_SEND_ROUTING_INFORMATION service (referred to as SRI herein). Depending on the traffic case of which the service is used, different information can be provided in its request/invoke and response/result messages. All the parameters available in the request and the response for the MAP_SEND_ROUTING_INFORMATION are listed in the following table.

| Parameter name | Request | Indication | Response | Confirm |
|---|---|---|---|---|
| Invoke Id | M | M(=) | M(=) | M(=) |
| Interrogation Type | M | M(=) | | |
| GMSC or gsmSCF Address | M | M(=) | | |
| MSISDN | M | M(=) | C | C(=) |
| OR Interrogation | C | C(=) | | |
| OR Capability | C | C(=) | | |
| CUG Interlock | C | C(=) | C | C(=) |
| CUG Outgoing Access | C | C(=) | C | C(=) |
| Number of Forwarding | C | C(=) | | |
| Network Signal Info | C | C(=) | | |
| Supported CAMEL Phases | C | C(=) | C | C(=) |
| Suppress T-CSI | C | C(=) | | |
| Offered CAMEL 4 CSIs | C | C(=) | | |
| Suppression of Announcement | C | C(=) | | |
| Call Reference Number | C | C(=) | | |
| Forwarding Reason | C | C(=) | | |
| Basic Service Group | C | C(=) | | |
| Basic Service Group 2 | C | C(=) | | |
| Alerting Pattern | C | C(=) | | |
| CCBS Call | C | C(=) | | |
| Supported CCBS Phase | C | C(=) | | |
| Additional Signal Info | C | C(=) | | |
| IST Support Indicator | C | C(=) | | |
| Pre-paging supported | C | C(=) | | |
| Call Diversion Treatment | C | C(=) | | |
| Indicator | | | | |
| Long FTN Supported | C | C(=) | | |
| Suppress VT-CSI | C | C(=) | | |
| Suppress Incoming Call | C | C(=) | | |
| Barring | | | | |
| gsmSCF Initiated Call | C | C(=) | | |
| Network Signal Info 2 | C | C(=) | | |
| IMSI | | | C | C(=) |
| MSRN | | | C | C(=) |
| Forwarding Data | | | C | C(=) |
| Forwarding Interrogation | | | C | C(=) |
| Required | | | | |
| VMSC address | | | C | C(=) |
| ReleaseResourcesSupported | | | C | C(=) |
| GMSC Camel Subscription | | | C | C(=) |
| Info | | | | |
| Location Information | | | C | C(=) |
| Subscriber State | | | C | C(=) |
| Basic Service Code | | | C | C(=) |
| CUG Subscription Flag | | | C | C(=) |
| North American Equal Access | | | U | C(=) |
| preferred Carrier Id | | | | |
| User error | | | C | C(=) |
| SS-List | | | U | C(=) |
| CCBS Target | | | C | C(=) |
| Keep CCBS Call Indicator | | | C | C(=) |
| IST Alert Timer | | | C | C(=) |
| Number Portability Status | | | U | C(=) |
| Supported CAMEL Phases in | | | C | |
| VMSC | | | | |
| Offered CAMEL 4 CSIs in | | | C | C(=) |
| VMSC | | | | |
| MSRN 2 | | | C | C(=) |
| Forwarding Data 2 | | | C | C(=) |
| SS-List 2 | | | C | C(=) |
| Basic Service Code 2 | | | C | C(=) |
| Allowed Services | | | C | C(=) |
| Unavailability Cause | | | C | C(=) |
| Provider error | | | | O |

The following convention is used for categorising parameters when defining the service primitives:

M the inclusion of the parameter is mandatory.

O the inclusion of the parameter is a service-provider option.

U the inclusion of the parameter is a service-user option.

C the inclusion of the parameter is conditional and can be used for the following purposes:

to indicate that if the parameter is received from another entity it must be included for the service being considered;

to indicate that the service user must decide whether to include the parameter, based on the context on which the service is used;

to indicate that one of a number of mutually exclusive parameters must be included (e.g. parameters indicating a positive result versus parameters indicating a negative result);

to indicate that a service user optional parameter (marked “U”) or a conditional parameter (marked “C”) presented by the service user in a request or response type primitive is to be presented to the service user in the corresponding indication or confirm type primitive;

(=) when appended to one of the above, this symbol means that the parameter takes the same value as the parameter appearing immediately to its left;

“blank” the parameter is not present.

The Mobile Station International Subscriber Directory Number (MSISDN) together with International Mobile Subscriber Identity (IMSI) are two important numbers used for identifying a mobile subscriber. IMSI identifies the Subscriber Identity Module (SIM) card in the mobile phone, and the MSISDN is used for routing calls to the mobile subscriber. A SIM is uniquely associated to an IMSI, while the MSISDN can change in time (e.g. due to number portability), whereby different MSISDNs can be associated to the SIM.

If a mobile subscriber is not from the service provider network, the IMSI must be converted to a Global Title (GT), which can then be used for accessing the subscriber's data in the remote HLR. This is relevant to international mobile roaming. GT is a unique address set and used with the SCCP of SS7. This specific address can be used to globally address, and therefore identify, each SCCP node. The GT address can also be used to identify the network service provide network to which the GT belongs, as addresses are nationally and internationally coordinated. There are three main types of GT addresses in use in mobile networks:

E.164 (MSISDN)=CC+NDC+SN

E.212 (IMSI)=MCC+MNC+MSIN

E.214 (MGT)=combination of E.212 and E.164

An International Mobile Subscriber Identity (IMSI) is a unique number associated with all GSM and UMTS network mobile phone users. It is stored in the SIM inside the phone and is sent by the phone to the network. IMSI is used as a key in the HLR and therefore used for acquiring other details of the mobile terminal in the HLR or as locally copied in the VLR. The first 3 digits of the IMSI are the Mobile Country Code (MCC), and are followed by the Mobile Network Code (MNC), either 2 digits (European standard) or 3 digits (North American standard). The remaining digits are the mobile station identification number (MSIN) within the network's customer base, thus IMSI=MCC+MNC+MSIN.

MSISDN is a number uniquely identifying a subscription in a GSM or a UMTS mobile network. MSISDN is maximised to 15 digits, prefixes not included (e.g. 00 prefixes an international MSISDN when dialling from Sweden). There are 2 definitions of MSISDN, depending on the variant:

In GSM and its variant DCS 1800, MSISDN is built up as:

MSISDN=CC+NDC+SN

CC=Country Code

NDC=National Destination Code, identifies one or part of a PLMN

SN=Subscriber Number

In the GSM variant PCS 1900, MSISDN is built up as:

MSISDN=CC+NPA+SN

CC=Country Code

NPA=Number Planning Area

SN=Subscriber Number

The MSISDN in international format identifies the country and service provider of the called subscriber. By performing a SRI Invoke Request using the mobile subscriber's MSISDN, the SRI Result provides the subscriber's IMSI and also the Mobile Station Roaming Number (MSRN). The IMSI contains similar information to identify the country and service provider of the called subscriber.

The MSRN is an E.164 defined telephone number used to route telephone calls in a mobile network from a GMSC (Gateway Mobile Switching Centre) to the target MSC. The MSRN contains the current visitor country code (VCC), the visitor national destination code (VNDC), and the identification of the current MSC together with the subscriber number. The SRI Result parameter MSRN contains the “country code” and the “network code” and this identifies the country and service provider in which the called mobile terminal is roaming. Since MSRN(s) are allocated uniquely to each MSC, a MSRN identifies the MSC closest to the location of the called mobile terminal.

Embodiments of the system and method of the present invention identify the country and also the Mobile Switching Center (MSC) in which the cardholder mobile terminal 101 is located. By utilising the MAP SRI service, it is possible to derive the following information for a given mobile subscriber:

MSISDN

IMSI (retrieved in SRI Response)

MCC (derived from the IMSI)

MNC (derived from the IMSI)

VMSC (derived from MSRN)

VMSC Address (retrieved in SRI Response)

VMSC MCC (Derived from the MSRN)

VMSC MNC (Derived from the MSRN)

Based on the above information, the following information can also be identified:

Home Operator Name

Home Operator Country

Current MSC Operator

Current MSC Country

A further method for determining the cardholder's mobile handset location, uses a mobile application processed by the cardholder's mobile handset 101. A prerequisite for this method is that the cardholder's mobile handset 101 includes positioning means 206.

The mobile application is either pre-installed on phones during manufacture, or downloaded by the cardholder from the host terminal 103, from remote application stores or from any other mobile software distribution platform. The system and method are portable to existing and future mobile application platforms, such as. Java ME, Symbian, Android, .NET Compact Framework, Qt (framework), BREW, Windows Mobile, Palm OS, Flash Lite, Microbrowser, Blackberry, iPhone OS and more.

A mobile application is processed by the cardholder's GPS enabled mobile handset 101. A network of 24 satellites 110 supports the GPS navigational system. These satellites orbit the Earth in cyclic patterns 24 hours a day. At any given time, a minimum of 4 satellites signals is accessible to any one point on Earth. Whenever a mobile terminal 101 is activated, radio waves are sent out and the satellites know to start tracking the device. The exact location of a terminal is determined through a process called trilateration, wherein three satellites collaborate to narrow down potential location points, while a fourth satellite compiles the data and decides on a match. Distance calculations are made based on the time it takes the radio signals to travel back and forth between terminal and satellites. The mapping capabilities are displayed on the phone handset via the cellular provider's database. The accuracy of these maps depends on how frequently the mobile provider updates their database.

The application is further capable of accommodating additional GPS methods such as assisted GPS. Assisted GPS addresses the limitation of direct line of sight required for GPS techniques, and is useful when the electronic transaction takes place inside a building, in which case GPS may not work. Assisted GPS is an improved technique which uses a cellular network's assistance server that is connected to a reference network. Through the use of cell towers, a phone relays GPS satellite signal information to the server. The server is adapted to process incoming data at much higher rates than GPS—enabled terminals, so information is transmitted quicker, and is typically more accurate than what a mobile terminal can relay on its own.

The mobile application is processed as a background service or thread by the mobile handset 101. The application is triggered when a message is sent from the system of the invention to the mobile handset 101. The trigger can be sent from the system to the mobile application in many different ways, some of which are covered below;

SMS (or MMS) Message

WAP Message

USSD Message

Java Remote Method Invocation (Java RMI), XML, RPC, SOAP, HTTP, HTTPS request, CORBA request.

When triggered by the system, the mobile application returns the current geographical coordinates of the mobile handset 101 to the system. The response message with the geographical coordinates can be sent from the cardholder's mobile handset 101 to the system in the same manner as it was received, such as:

SMS (or MMS) Message

WAP Message

USSD Message

Java Remote Method Invocation (Java RMI), XML, RPC, SOAP, HTTP, HTTPS request, CORBA request.

The system then uses the geographical coordinates received from the cardholder mobile application to determine if the cardholder is in near proximity to the terminal 102 at which an electronic transaction associated with the cardholder's card is taking place. The location accuracy depends on the type of positioning technique being used, and the system preferably integrates with any type of mobile positioning system.

In an embodiment of the cardholder mobile location system, the financial institution terminal 103 supplies the system with the following information: actual or aliased cardholder account number, location of the electronic transaction including country (this information can be for example the physical address of the merchant and/or POS, POS terminal ID (the system may perform a look up to determine the address of the terminal), time of transaction, actual or aliased transaction ID and, optionally, mobile number of the cardholder (depending on whether the cardholder is registered according to FIGS. 5 and 6 or not). This information can be sent from the financial institution to the invention in different formats, either as a file using FTP/SFTP or as data over HTTP/HTTPS/CORBA, XML, etc. The information can also be sent as one by one transaction or in batches of multiple transactions.

The system receives the file or data and processes each transaction. If the mobile number of the card holder is not provided in the information, the system looks it up based on the account number received, provided the cardholder is registered according to FIGS. 5 and 6 or its number has at least been verified according to FIGS. 3 and 4.

For each transaction, the system obtains the location of the cardholder's mobile handset 101 by contacting the Mobile Positioning Interface integrated with a Mobile Location Service. The Mobile Location Service can use any of the techniques described above to obtain the location of the handset.

The Mobile Location Service determines the position and sends the geo-coordinates (X, Y) of the mobile handset 101 back to the system. In its simplest form, the Mobile Location Service returns the result of a SRI lookup so that the system may determine the country or MSC in which the handset is. Alternatively, the location is retrieved using a mobile application processed by the cardholder's GPS enabled mobile handset 101, or any of the Mobile Positioning techniques described above.

In parallel to locating the mobile handset position, the system also determines the location of the ATM, POS or Merchant by looking up the address of the ATM, POS or Merchant or querying the database to obtain the geo-location (or address) of the Terminal ID.

When both the position of the cardholder's mobile handset 101 and the position at which the transaction is taking place are known, the system compares the locations and, based on predetermined criteria, for instance if the distance is greater than a defined (configurable) value, determines whether the transaction appears fraudulent or not. The predetermined criteria can be based on country, or a configurable distance between the location of the card transaction and the location of the cardholder's mobile handset. If the transaction appears fraudulent under the criteria, the system raises an alarm or flags the transaction. The system then records the alarm or flag against the transaction in the database 306 and return the information to the financial institution terminal 301, so that it may cancel or query the electronic transaction.

With reference to FIG. 7, the system thus comprises the terminal 103 configured as a plurality of function—specific servers 701, 702, 703, 704, 705, 706 and storing the database 306. The function—specific servers are adapted to allow the financial institution terminal 301, via the suitably configured terminal 103, to determine the location of a cardholder's mobile terminal 101 in relation to the location of an electronic transaction using the card number of that cardholder. The assumptions of this system are that the cardholder has registered the correct mobile number for the account number associated with the card, for instance with the mobile phone network address registration system of FIGS. 5 and 6 described hereinabove, and that the cardholder is carrying the mobile terminal 101 at the time of performing the electronic transaction.

The account number, optionally the phone number (if the phone number has not been registered with the registration system of FIGS. 5 and 6), and a point of sale (POS) terminal identifier, automatic teller machine (ATM) identifier or merchant address are communicated to the cardholder mobile location system. The information can be received over any available interface, such as HTTP, HTTPS, CORBA, XML, FTP, SFTP and the like.

The cardholder mobile location system retrieves the location of the merchant 707, POS 708 or ATM 709, either by looking up addresses previously forwarded by the financial institution terminal 301 and stored in the database 306, or by retrieving this information through other means, for instance from a remote information server across the WAN 104.

In parallel, the cardholder mobile location system determines the location of the cardholder's mobile terminal 101 using one amongst different techniques as described above, selected according to which mobile position location services are available, such as handset location services using a handset GPS 206, or network based location services using various mobile positioning techniques described hereinafter.

The cardholder mobile location system then compares the location of the cardholder's mobile terminal 101 to the location of the merchant 707, POS 708 or ATM 709 associated with the electronic payment transaction and, depending on the embodiment, these steps of retrieving, determining and comparing are performed substantially in real time when the electronic payment transaction is initiated, or are performed at a later time, individually or in batches.

The cardholder mobile location system performs the comparison under predetermined rules to determine whether the electronic payment transaction should be considered fraudulent or not. For instance, the comparison can be based on whether the cardholder mobile terminal 101 is in the same country, or region, or city, or street as the merchant 707, POS 708 or ATM 709 associated with the electronic payment transaction.

If the comparison yields a location mismatch under the under predetermined rules, the electronic payment transaction is flagged as potentially fraudulent and this information is communicated to the financial institution terminal 301, either in real-time or offline in batch files. The financial institution may then take any appropriate actions under known procedures, for instance preventing use of the card in any further electronic payment transactions, querying the cardholder about the genuine character of the flagged transaction, and more, all such known procedures being outside the scope of the present disclosure.

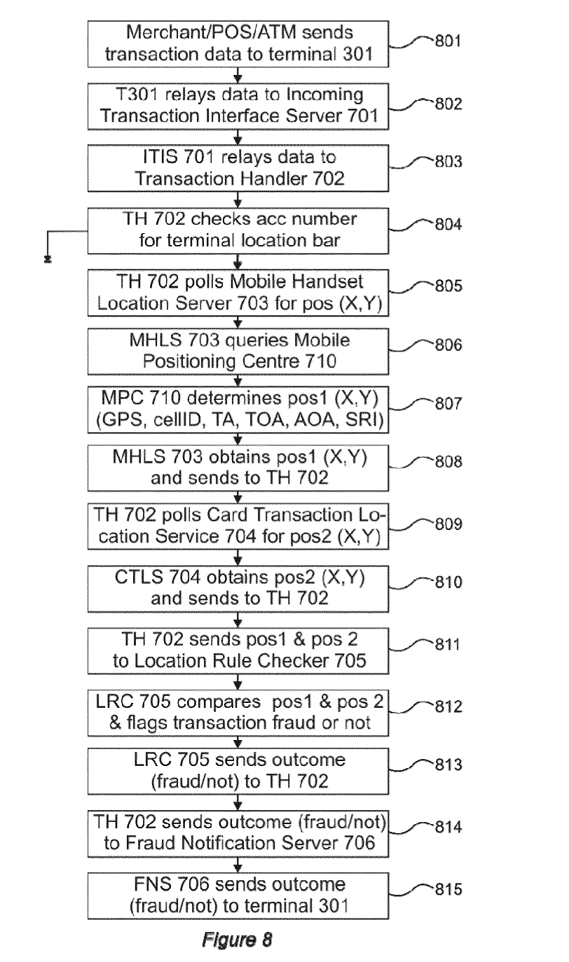

Steps according to which the system of FIG. 7 locates a cardholder mobile terminal 101 are detailed in FIG. 8.

At step 801, the merchant 707, POS 708 or ATM 709 forwards data representative of an electronic transaction to the financial institution terminal 301.

At step 802, the financial institution card handling system 301 forwards the card transaction data to the host terminal 103, including the account number, terminal ID/merchant address/POS address and the actual or aliased account number. The information can be forwarded over any available interface, such as HTTP, HTTPS, CORBA, XML, FTP, SFTP and the like. Incoming card transaction data is received in the Incoming Transaction Interface Server 701.

At step 803, the Incoming Transaction Interface Server 701 forwards the incoming card transaction data to the Transaction Handler 702.

At step 804, the Transaction Handler 702 checks that the account number is not restricted as regards the terminal locating feature (for instance, the Transaction Handler 702 checks the Mobile Positioning Flag in the database 306). If the account number is restricted for the locating feature, the system stops any further action for the account number and returns an appropriate response to the financial institution terminal 301.

If there is no restriction, then at step 805 the Transaction Handler 702 polls the Mobile Handset Location Server 703 to obtain the location of the cardholder's mobile terminal 101.

At step 806, the Mobile Handset Location Server 703 interfaces with a Mobile Positioning Centre 710 in order to obtain the handset location.

At step 807, the MPC 710 uses any supported technique to determine the handset location, e.g. GPS, Cell Identity, Timing Advance (TA), Time of Arrival (TOA), Send Routing Information (SRI), etc and relays the determined location back to the Mobile Handset Location Interface 703 in the system.

At step 808, the Mobile Handset Location Interface 703 forwards the received location to the Transaction Handler 702, which then contact a Card Transaction Location Service 704 to determine the location of the card transaction at step 809. This information can either be passed in from the financial institutions terminal 301 as part of the incoming information of step 801, or it can be a lookup of the POS terminal ID to retrieve the address.

At step 810, the Card Transaction Location Service 704 obtains the location of the card transaction and forwards it to the Transaction Handler 702.

At step 811, the Transaction Handler 702 forwards both the location of the mobile handset 101 obtained at step 808 and the location of the card transaction obtained at step 809 to a Location Rule Checker 705.

At step 812, the Location Rule Checker 705 compares the two locations and determines whether the transaction should be marked or flagged as fraudulent or not. The rules processed by the Location Rule Checker 705 are flexible and configurable. For example, one rule may specify that the card transaction and the mobile phone must be located the same country, or that a location is deemed to match if both are within a defined distance of one another, etc.

At step 813, the Location Rule Checker 705 returns the outcome of the comparison to the Transaction Handler 702.

At step 814, the Transaction Handler 702 then forwards the outcome to the Fraud Notification Server 706. The Fraud Notification Server 706 is adapted to handle individual or multiple card transactions and, at step 815, relays information about one or more electronic transactions deemed fraudulent to the financial institution card handling system 301.

The financial institution may then determine which action to take on the basis of the received information. For example, for real-time transactions, an ATM withdrawal may be rejected, or a card transaction authorisation may be refused, or a merchant may be informed that the transaction is not legitimate.

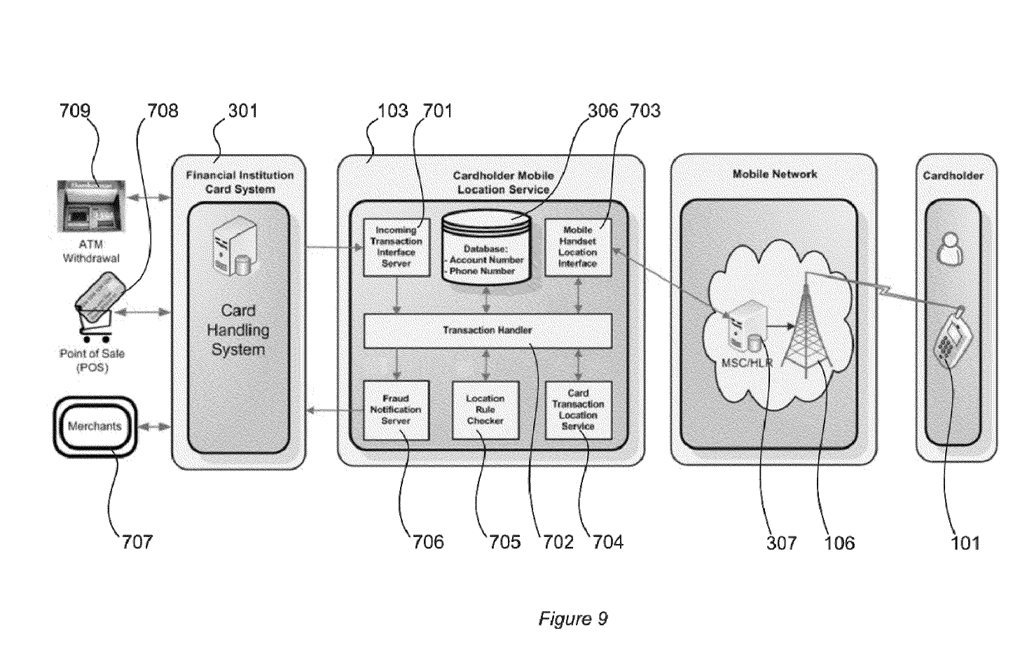

FIG. 9 shows another cardholder mobile location system embodied in the environment of FIG. 1 according to the present invention. This embodiment is substantially similar to the embodiment shown in FIG. 7, but relates to the case wherein a Send Routing Information Request with the MSISDN is sent to the HLR 307 to determine the MSC (and thereby the location) at which the cardholder's mobile terminal 101 is located. Processing steps for this embodiment are substantially similar as those described in connection with FIG. 8.

The cardholder mobile location service allows the financial institution terminal 301 to check where a cardholder's mobile phone is located in relation to the location of the transaction for the card number associated with the transaction. The assumption of this embodiment is that the cardholder has registered the correct terminal network address for the account number, which could be done using the system and method of FIGS. 5 and 6, and that the cardholder is carrying the mobile terminal 101 at the time of performing the electronic transaction.

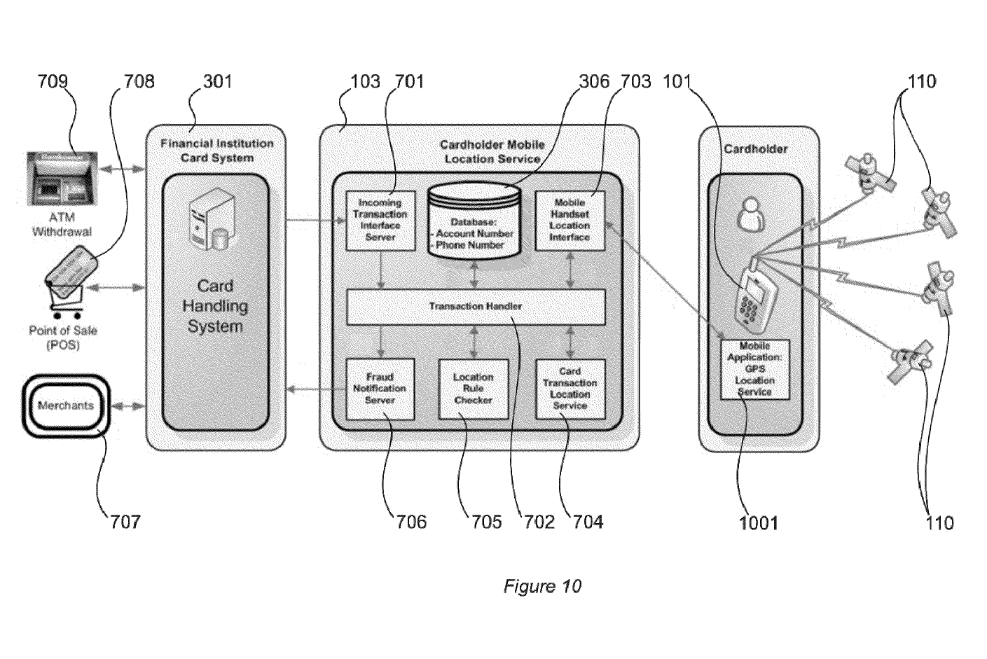

FIG. 10 shows another cardholder mobile location system embodied in the environment of FIG. 1 according to the present invention. This embodiment is substantially similar to the embodiments shown in FIGS. 7 and 9, but relates to the case wherein a cardholder has a GPS enabled mobile terminal 101 and has installed a mobile application for GPS Location Service on the mobile terminal 101.

As before, the system allows for incoming card transactions to be checked. The account number and the network address, e.g. the phone number (unless the network address is already stored within the system database 306) and the terminal ID, POS or Merchant address are communicated to the system.

The system retrieves the position of the Merchant, POS or ATM by either looking up the addresses defined within the system, having it passed in from the financial institution terminal 301, or by retrieving this information by other means. The system identifies the cardholder's terminal location using a mobile application installed on the mobile handset 101 and the GPS functionality 206 of the mobile handset 101.

The system retrieves the location of the cardholder's mobile terminal 101 and compares it to the location of the card transaction. The system compares the location and uses internal rules to determine whether the electronic transaction should be considered fraudulent or not. The comparison can again be based on whether the cardholder mobile terminal 101 is in the same country as the card transaction or not, or within a predetermined distance, for instance whether the cardholder terminal is in the same city, on the same street, etc. as the Merchant, POS or ATM.

If the card transaction is flagged as potentially fraudulent by the system, this information is forwarded to the financial institution terminal 301 either in real-time or offline in batch files. The financial institution terminal 301 can then determine whether to block the card transaction, or query the cardholder about the transaction.

The processing steps of the system of FIG. 10 follow substantially those of FIG. 8.

Initially, the ATM, POS or Merchant forwards the card transaction data to the financial institution terminal 301. The financial institution card handling system 301 integrates with the system and forwards the card transaction data to the system. The incoming card transactions are received in the Incoming Transaction Interface Server 701, including the actual or aliased account number, terminal ID or POS or Merchant address.

The Incoming Transaction Interface Server 701 forwards the incoming card transaction data to the Transaction Handler 702. The Transaction Handler 702 checks that the account number is not restricted about the terminal locating feature, for instance by checking the Mobile Positioning Flag in the database 306. If the account number is restricted about this feature, the system stops any further action for this account number and returns an appropriate response to the financial institution terminal 301.

If there is no restriction about the terminal locating feature, then the Transaction Handler 702 contacts the Mobile Handset Location Server 703 to obtain the location of the cardholder's mobile terminal 101. The Mobile Handset Location Server 703 triggers the mobile application processed by the cardholder's mobile terminal 101. The mobile application recognises the incoming message from the system and starts to retrieve the GPS position. The communication between the system and the mobile terminal can be either via a SMS message issued from the Mobile Handset Location Interface 703, or it can be a WAP message issued form the Mobile Handset Location Interface 703, or a USSD message issued from the Mobile Handset Location Interface 703. Alternatively, provided that the cardholder's mobile terminal 101 is connected to the Internet 104, the system can trigger the mobile application using any sort of remote invocation method, such as Java Remote Method Invocation (Java RMI), XML, RPC, SOAP, HTTP, HTTPS request, CORBA request, and the like.

The mobile application processed by the cardholder mobile terminal 101 uses the GPS device 206 in the mobile handset 101 to retrieve the geographical coordinates of the mobile handset. The mobile application subsequently returns the geographical coordinates of the cardholder mobile terminal to the system.

The Mobile Handset Location Interface 703 forwards the location to the Transaction Handler 702, which then polls the Card Transaction Location Service 704 to determine the location at which the card transaction is taking place. This information can either be passed in from the financial institution terminal 104 as part of the incoming information, or it can be a lookup of the Terminal ID to retrieve the address.

The Card Transaction Location Service 704 returns the location of the card transaction to the Transaction Handler 702, which then forwards the respective locations of the mobile handset 101 and the card transaction 707, 708, 709 to the Location Rule Checker 705.

The Location Rule Checker 705 compares the two locations and determines whether the transaction should be marked as fraudulent or not, then returns the outcome to the Transaction Handler 702. The Transaction Handler 702 then forwards the response to the Fraud Notification Server 706, which has the ability to handle individual or multiple card transactions. The Fraud Notification Server 706 relays the information to the financial institution card handling system 301.

The financial institution can then determine what action to take on the basis of the information determined by the system.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

1. A method of processing location data associated with a transaction in an electronic transaction processing system, the system comprising at least one point of sale terminal and at least one cardholder mobile terminal, each terminal being connected to a network and associated with a same electronic transaction, the method comprising the steps of:
obtaining data representative of the geographical location of the at least one point of sale terminal;
obtaining data representative of the geographical location of the at least one cardholder mobile terminal;
comparing the respective positional data of the at least one point of sale terminal and of the at least one cardholder mobile terminal; and
communicating an alert message over the network if the comparison indicates that the at least one point of sale terminal and the at least one cardholder mobile terminal are not located within a predetermined proximity to one another.

2. A method according to claim 1, comprising the further steps of
associating a network address of the at least one cardholder mobile terminal with a unique identifier representative of a respective financial account or payment card; and
associating the associated network address and unique identifier with a financial institution host terminal.

3.-7. (canceled)

8. A method according to claim 1, wherein the predetermined proximity is a geographical area selected from the group comprising administratively—defined areas, network—defined areas, areas determined by the at least one cardholder mobile terminal, or any combination thereof.

9. A method according to claim 8, wherein the step of obtaining data representative of the geographical location of the at least one cardholder mobile terminal comprises the further step of sending a Mobile Application Part (MAP) message over the network.

10. A method according to claim 9, wherein the step of obtaining data representative of the geographical location of the at least one cardholder mobile terminal comprises the further step of sending a Mobile Application Part (MAP) message over the network, and the step of sending a MAP message comprises the further step of sending a MAP Send Routing Information (SRI) or Send Routing Information Short Message query.

11. A method according to claim 8, wherein the at least one cardholder mobile terminal comprises global positioning means and the step of obtaining data representative of the geographical location of the at least one cardholder mobile terminal comprises the further step of obtaining global positioning coordinates from the at least one cardholder mobile terminal.

12. A method according to claim 1, comprising the further step of authenticating the transaction if the comparison indicates that the at least one point of sale terminal and the at least one cardholder mobile terminal are located within the predetermined proximity to one another.

13. A method according to claim 1, wherein the steps of obtaining data respectively representative of the geographical location of the at least one point of sale terminal and of the at least one cardholder mobile terminal, comparing the respective positional data and communicating an alert message over the network are performed by a host terminal connected to the network.

14. (canceled)

15. An electronic payment system comprising at least one point of sale terminal and at least one cardholder mobile terminal, the system comprising:
means for obtaining data representative of the geographical location of the at least one point of sale terminal;
means for obtaining data representative of the geographical location of the at least one cardholder mobile terminal;
means for comparing the respective positional data of the at least one point of sale terminal and of the at least one cardholder mobile terminal; and
means for communicating an alert message over the network if the comparison indicates that the at least one point of sale terminal and the at least one cardholder mobile terminal are not located within a predetermined proximity to one another.

16. A system according to claim 15, further comprising
means for associating a network address of the at least one cardholder mobile terminal with a unique identifier representative of a respective financial account or payment card; and
means for associating the associated network address and unique identifier with a financial institution host terminal.

17.-21. (canceled)

22. A system according to any of claim 15, wherein the predetermined proximity is a geographical area selected from the group comprising administratively—defined areas, network—defined areas, areas determined by the at least one cardholder mobile terminal, or any combination thereof.

23. A system according to claim 22, wherein the means for obtaining data representative of the geographical location of the at least one cardholder mobile terminal is adapted to communicate a Mobile Application Part (MAP) message over the network.

24. A system according to claim 23, wherein the means for obtaining data representative of the geographical location of the at least one cardholder mobile terminal is adapted to communicate a Mobile Application Part (MAP) message over the network the obtaining means is further adapted to communicate a MAP Send Routing Information (SRI) or Send Routing Information Short Message query.

25. A system according to claim 22, wherein the means for obtaining data representative of the geographical location of the at least one cardholder mobile terminal is a global positioning means of the at least one cardholder mobile terminal.

26. A system according to claim 15, further comprising means for authenticating the transaction if the comparison indicates that the at least one point of sale terminal and the at least one cardholder mobile terminal are located within the predetermined proximity to one another.

27. A system according to claim 15, wherein the means for obtaining data respectively representative of the geographical location of the at least one point of sale terminal and of the at least one cardholder mobile terminal, the means for comparing the respective positional data and the means for communicating an alert message over the network are embodied in a host terminal connected to the network.

28. (canceled)

29. A set of instructions recorded on a data carrying medium which, when processed by a data processing terminal connected to a network, configures the terminal to perform the steps of
obtaining data representative of the geographical location of at least one point of sale terminal connected to the network or another network and associated with an electronic transaction;
obtaining data representative of the geographical location of at least one cardholder mobile terminal connected to the network or another network and associated with the electronic transaction;
comparing the respective positional data of the at least one point of sale terminal and the at least one cardholder mobile terminal; and
communicating an alert message over the network if the comparison indicates that the at least one point of sale terminal and the at least one cardholder mobile terminal are not located within a predetermined proximity to one another.

30.-31. (canceled)
